(19) United States
(12) Patent Application Publication
(10) Pub. No.: US 2021/0368588 A1
(43) Pub. Date: Nov. 25, 2021

(54) VEHICLE-MOUNTED GLASS HEATER SECURING STRUCTURE, VEHICLE-MOUNTED GLASS HEATER UNIT, AND VEHICLE-MOUNTED GLASS HEATER MAINTENANCE METHOD

(71) Applicant: Kojima Industries Corporation, Toyota-shi (JP)

(72) Inventor: Hiroaki SEMBA, Toyota-shi (JP)

(21) Appl. No.: 17/320,847

(22) Filed: May 14, 2021

(30) Foreign Application Priority Data
May 22, 2020 (JP) 2020-089705

(51) Int. Cl. H05B 3/84; B60R 11/04; H05B 3/20; H05B 3/06

(52) U.S. Cl. CPC H05B 3/84; B60R 11/04; B60R 2011/0026; H05B 3/06; H05B 3/20

(57) ABSTRACT

Provided is a vehicle-mounted glass heater securing structure including a bracket, a hood, and a heater. A camera is secured on the bracket. The bracket is secured on an automobile. The hood is secured on the bracket. Between the hood and the windshield in front of the camera, the line of sight of the camera passes through. The hood supports the heater in a posture along the surface of the windshield, at a position in front of the camera with a gap formed between the heater and the windshield.

### CROSS REFERENCE TO RELATED APPLICATION

The present invention claims priority under 35 U.S.C. § 119 to Japanese Patent Application No. 2020-089705 filed on May 22, 2020, which the entire content of which is incorporated herein by reference.

### TECHNICAL FIELD

The present disclosure relates to a vehicle-mounted glass heater securing structure, a vehicle-mounted glass heater unit, and a vehicle-mounted glass heater maintenance method, in particular, a structure for securing a heater for use with window glass of an automobile, and a maintenance method for the heater.

### BACKGROUND

Some automobiles include a camera installed on the windshield inside of the vehicle cabin. Such a camera is used for automatic running control, for example. In such a use, the camera captures an image of an object that can be used as reference points for a running route, such as road lanes drawn on the roads, and sends video data to a running control device. The running control device executes automatic running control, based on the video data. The camera may also be used as a driving recorder.

On the windshield of an automobile having a camera, heating lines may run in an area in front of the camera, such as is described in Patent Literature 1. Heating with heating lines removes moisture in any state, such as a fogged state, a frozen state or the like, residing on the windshield. This removes such moisture that hinders a clear view of the camera, and thus improves the quality of images captured with the camera.

### CITATION LIST

### Patent Literature

Patent Literature 1: JP 2017-213981A
Patent Literature 2: International Laid-Open Publication 2018/230358

### SUMMARY

As described in Patent Literature 1, heating lines on a windshield are visually recognizable from outside the automobile, which some users may find not preferable in terms of visual quality. In addition, repairing such heating lines requires repairing the windshield as a whole. In view of the above, attachment of a heater in the form of a transparent thin film, such as is described in Patent Literature 2, on the windshield may be a solution to this problem. This method, however, may lead to formation of bubbles between the heater and the windshield and possible damage on the windshield or the heater when attaching the heater. This can impair the quality of images captured with a camera.

In view of the above, the present disclosure aims to achieve a vehicle-mounted glass heater securing structure that imposes less mechanical burden on the window glass of automobiles.

According to one aspect of the present disclosure, there is provided a vehicle-mounted glass heater securing structure including: a bracket having a camera secured thereon, the bracket for being secured on an automobile; and a hood secured on the bracket in such a manner that allows the line of sight of the camera to pass through between the hood and the glass in front of the camera, wherein the hood supports a heater in a posture along a surface of the glass at a position in front of the camera with a gap formed between the heater and the glass.

In one embodiment, the hood may have a recessed structure that is recessed in a direction departing from the glass, a support structure disposed outside the recessed structure, the support structure being for supporting the heater such that the heater covers the opening of the recessed structure, and a projecting portion disposed on the support structure and projecting toward the glass, and the tip end of the projecting portion may be in contact with the glass.

In one embodiment, the hood may have a recessed structure that is recessed in a direction departing from the glass, a support structure disposed outside the recessed structure, the support structure being for supporting the heater such that the heater covers the opening of the recessed structure, a projecting portion disposed on the support structure and projecting toward the glass, and an additional projecting portion projecting from the projecting portion toward the glass. The dimension of the height of the projecting portion may be the same as the dimension of the thickness of the heater, or smaller than the dimension of the thickness of the heater, and the tip end of the additional projecting portion may be in contact with the glass.

In one embodiment, the support structure may be a plane structure formed on the circumference of the recessed structure, and the projecting portion may be formed on the circumference of the plane structure.

In one embodiment, the hood may have a recessed structure that is recessed in a direction departing from the glass, the heater may be supported so as to cover the opening of the recessed structure, and the bracket may have a frame structure that surrounds the outside of the hood and a bracket projecting portion that projects from the frame structure toward the glass.

In one embodiment, the hood may have an L-shaped hook structure that extends from the hood, and a nailed hook structure that extends from the hood and elastically swings, and the nailed hook structure may be hooked on the bracket at a position opposed to the frame with the L-shaped hook structure engaged with the frame included in the bracket.

In one embodiment, with the nailed hook structure separated from the bracket, the hood may be rotatable with the engagement portion between the L-shaped hook structure and the frame as the center, and removable from the engagement portion.

According to another aspect of the present disclosure, there is provided a vehicle-mounted glass heater unit including the above-described vehicle-mounted glass heater securing structure and the heater, wherein the heater includes a low reflective film provided on the surface of the heater on the side of the glass or in an inside layer of the heater.

According to still another aspect of the present disclosure, there is provided a vehicle-mounted glass heater unit including the above-described vehicle-mounted glass heater securing structure and the heater, wherein the heater includes a base in a sheet-like shape or a plate-like shape, and the base is made of elastic or rigid material.

According to yet another aspect of the present disclosure, there is provided a vehicle-mounted glass heater unit including the above-described vehicle-mounted glass heater securing structure and the heater, wherein the heater includes a base in a sheet-like shape or a plate-like shape, and the base is made of glass material.

According to yet another aspect of the present disclosure, there is provided a vehicle-mounted glass heater maintenance method for use with a vehicle-mounted glass heater unit including a bracket having a camera secured thereon, the bracket for being secured on an automobile, a hood removably secured on the bracket in such a manner that allows the line of sight of the camera to pass through between the hood and the glass in front of the camera, and a heater supported in a posture along the surface of the glass of the automobile by the hood at a position in front of the camera, the method including the steps of: releasing hooking between the hood and the bracket, and rotating the hood in a direction departing from the glass with the engagement portion between the hood and the bracket at the center to separate the hood from the bracket; and demounting the heater from the hood.

In one embodiment, the vehicle-mounted glass heater maintenance method may further include the steps of securing the heater on the hood; and engaging the hood with the engagement portion, then rotating the hood in a direction approaching the glass with the engagement portion at the center, and hooking the hood on the bracket.

According to the present disclosure, it is possible to achieve a vehicle-mounted glass heater securing structure that imposes less mechanical burden on the window glass of an automobile.

### BRIEF DESCRIPTION OF DRAWINGS

An embodiment of the present disclosure will be described based on the following figures, wherein:

FIG. 1 illustrates an automobile equipped with a vehicle-mounted camera unit;

FIG. 2 is a perspective view of a vehicle-mounted camera unit;

FIG. 3 is an exploded perspective view of a vehicle-mounted camera unit;

FIG. 4 is a side view of a vehicle-mounted camera unit;

FIG. 5 illustrates a hood being demounting from a bracket;

FIG. 6 is a cross sectional view of a vehicle-mounted camera unit;

FIG. 7 schematically illustrates an exemplary structure for a hood to support a heater;

FIG. 8 schematically illustrates an exemplary structure for a hood to support a heater; and

FIG. 9 schematically illustrates an exemplary structure for a hood to support a heater.

Referring to the following drawings, an embodiment of the present disclosure will be described. Note that terms such as up, down, left, and right used in the specification of this application refer to the respective directions as viewed by an occupant in an automobile. Further, identical components illustrated in two or more drawings are given the same reference numerals, and are described only simply.

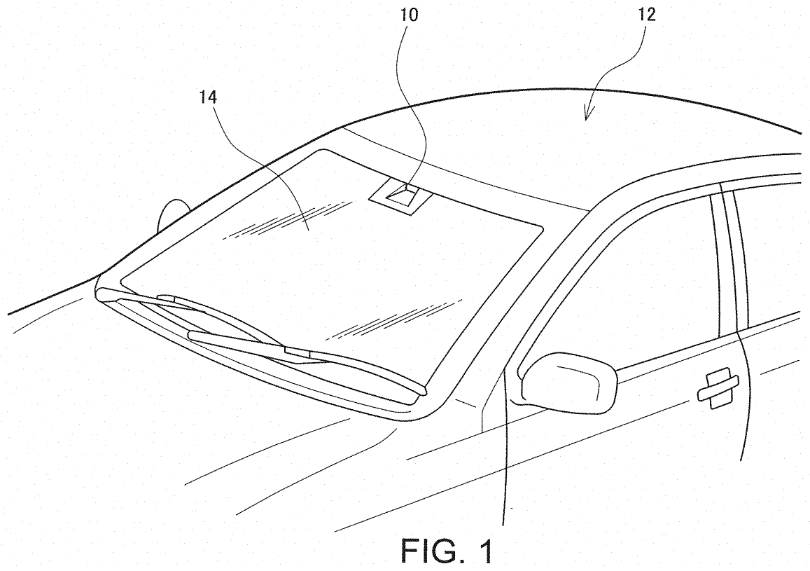

FIG. 1 illustrates an automobile 12 carrying a vehicle-mounted camera unit 10 (a vehicle-mounted glass heater unit) according to an embodiment of the present disclosure. The vehicle-mounted camera unit 10 is secured on an upper portion of a surface of a windshield 14 on the side of the vehicle cabin. The vehicle-mounted camera unit 10 is used for automatic running control, for example. Specifically, in this case, the vehicle-mounted camera unit 10 captures an image of an object that constitutes reference points of a running route, such as road lanes drawn on the roads, and sends video data to a running control device. The running control device executes automatic running control, based on the video data. The vehicle-mounted camera unit 10 may also be used as a driving recorder.

It is sometimes a case that moisture in any state, such as a fogged state, a frozen state or the like, is present on a surface of the windshield 14. Moisture on the windshield 14 may impair the quality of an image captured by the camera. To address this, a heater for heating the windshield 14 is equipped on the vehicle-mounted camera unit 10.

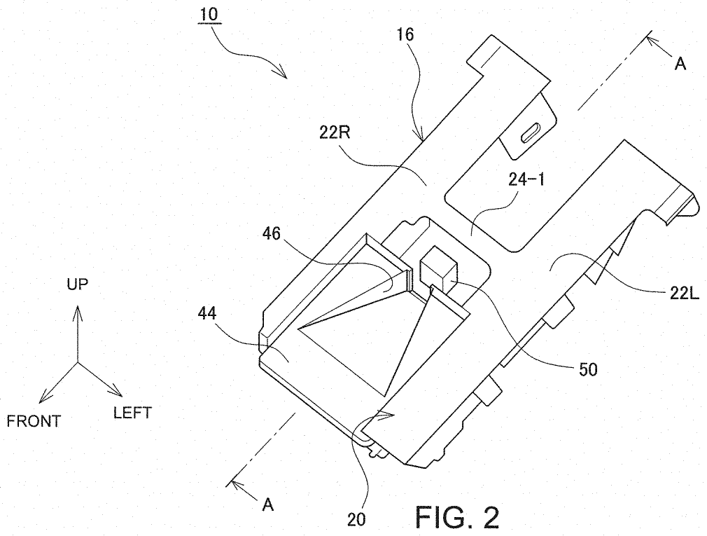

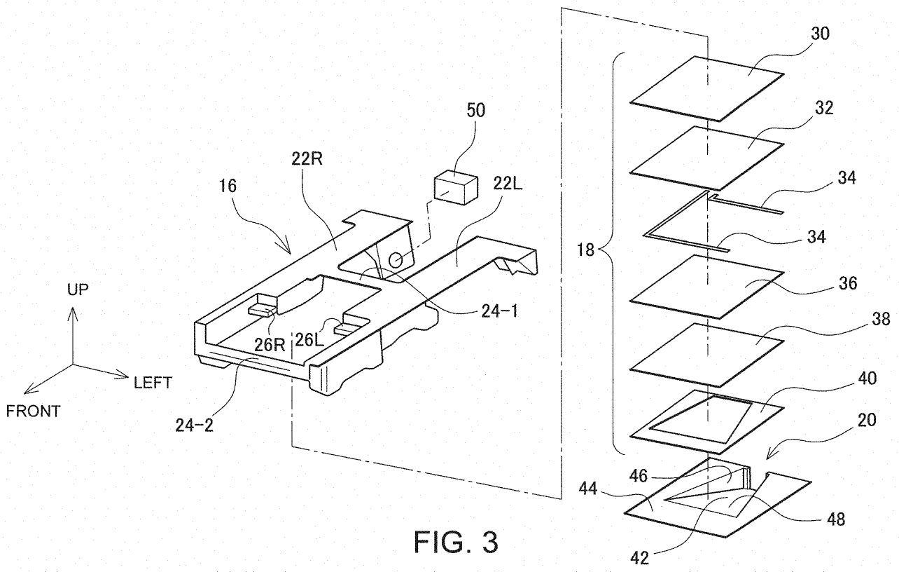

FIG. 2 is a perspective view of the vehicle-mounted camera unit 10. FIG. 3 is an exploded perspective view of the vehicle-mounted camera unit 10. The vehicle-mounted camera unit 10 includes a bracket 16, a heater 18, a hood 20, and a camera 50. As illustrated in FIG. 3, the bracket 16 is composed of right and left front-back frames 22R, 22L extending parallel to each other in the front-back direction, and two lateral frames 24-1, 24-2 extending parallel to each other in the lateral direction. The lateral frame 24-1 straddles the respective middle portions of the front-back frames 22R, 22L, while the lateral frame 24-2 straddles the respective tip end portions of the front-back frames 22R, 22L.

At a position on the front-back frame 22R between a position where the lateral frame 24-1 extends leftward and a position where the lateral frame 24-2 extends leftward, a hood attachment projection 26R is formed. The inside edge and inside lateral surface of the front-back frames 22R bend outward as they extend forward from the back, and then bend again to extend forward. The hood attachment projection 26R is formed in a section where the inside edge and the lateral surface of the front-back frame 22R bend outward, so as to project forward from a lower part of the lateral surface that faces forward.

Similarly, at a position on the front-back frame 22L between a position where the lateral frame 24-1 extends rightward and a position where the lateral frame 24-2 extends rightward, a hood attachment projection 26L is formed. The inside edge and inside lateral surface of the front-back frame 22L bend outward as they extend forward from the back, and then bend again to extend forward. The hood attachment projection 26L is formed in a section where the inside edge and the lateral surface of the front-back frame 22L bend outward, so as to project forward from a lower part of the lateral surface that faces forward. The bracket 16 can be made of plastic resin.

The hood 20 has a recessed structure 42 that is recessed toward the vehicle chamber. The recessed structure 42 is recessed by the largest amount at its rear end portion, and expands forward while widening and being recessed by a gradually lesser amount as it goes forward until its front end, which is connected to a plane structure 44. That is, the recessed area, which is a recessed portion of the recessed structure 42, is surrounded by a trapezoidal base surface 48 that is inclined such that its front portion is positioned higher, and triangular lateral walls 46 each having a vertex at its front and standing upright from the respective right and left edges of the trapezoidal base surface 48. The recessed area is open upward and rearward. Behind the recessed area, the camera 50 is secured on the bracket 16.

The plane structure 44 is formed along the circumference of the opening of the recessed structure 42. The plane structure 44 has a rectangular circumferential edge. The heater 18 is placed on the top of the plane structure 44. The hood 20, having the heater 18 placed thereon, is secured on the bracket 16. In other words, the hood 20, having the heater 18 thereon, is secured in an area more forward than the hood attachment projections 26R, 26L in an area surrounded by the front-back frame 22R, the lateral frame 24-1, the front-back frame 22L, and the lateral frame 24-2 of the bracket 16. A specific structure for securing the hood 20 on the bracket 16 will be described later in detail.

The heater 18 has a first base 30, an optical clear adhesive, or OCA, 32, two electrodes 34, a metal film 36, a second base 38, and a double-sided sticky tape 40. These components can be made of an optically transmissive material, such as a transparent material, and formed into a shape like a sheet or a plate. These components can have such a transparency that does not hinder image capturing with the camera 50. The first base 30, the OCA 32, the two electrodes 34, the metal film 36, and the second base 38 are placed one on the other in this order, and adhered to one another. The first base 30 and the second base 38 are made of elastic or rigid material to enhance the mechanical strength of the heater 18. The second base 38 may be made of glass material, such as plastic glass or quartz glass. In a case where the second base 38 is made of glass material, such a second base 38 is less prone to discoloration due to UV radiation or other causes, which prevents impairing of the quality of images captured with the camera 50. Alternatively, the electrode 34 may be made of non-transparent material, and disposed at a position outside the field of view of the camera 50. As a further alternative, a structure including neither the first base 30 nor the OCA 32 may be employed, depending on the design conditions.

A low reflective film may be placed on the upper surface of the base 30. A low reflective film may be a thin film made of material with a low refractive index, such as SiO₂ and MgF₂. A low reflective film may be a film containing an SiO₂ layer, an MgF₂ layer, or a combination of an SiO₂ layer and MgF₂ layer. The low reflective film may be formed by disposing two or more layers made of a material with a low refractive index on the upper surface of the base 30. Alternatively, a pre-formed low reflective thin film may be placed on the upper surface of the base 30. Use of a low reflective film enables prevention of reflection of the heater 18 by the windshield 14.

Through the same process mentioned above, a low reflective film may be formed on the upper side of the two electrodes 34. In this case, the first base 30 and the OCA 32 may not be used. As such, the heater 18 may have a low reflective film formed on its surface on the side of the windshield 14 or on its inside layer.

One end of each electrode 34 is electrically connected to the metal film 36, and the other end of each electrode 34 is drawn out from the heater 18. The other ends of the electrodes 34, drawn out from the heater 18, constitute a pair of power supply terminals. With a voltage applied to the pair of power supply terminals, a current flows in the metal film 36, and the metal film 36 generates heat. The heater 18 is secured on the upper surface of the plane structure 44 of the hood 20 with the double-sided sticky tape 40 disposed lowest. This leaves the opening of the recessed structure 42 of the hood 20, covered by the heater 18.

A portion of the bracket 16 more rearward than the hood 20 is secured on the automobile. For example, respective portions of the front-back frames 22R, 22L more rearward than the hood 20 are secured on the vehicle body on the side of the vehicle chamber at a position more upward than the upper edge of the windshield 14, illustrated in FIG. 1. Alternatively, the bracket 16 may be secured on the windshield 14. Either securing method leaves the bracket 16 in a posture having the camera 50 with its line of sight directed forward through the windshield 14. The line of sight of the camera 50 passes through between the windshield 14 in front of the camera 50 and the recessed structure 42 of the hood 20. The hood 20 blocks unnecessary light for the camera 50. The heater 18, covering the opening of the recessed structure 42 of the hood 20, is opposed to the surface of the windshield 14 on the side of the vehicle chamber.

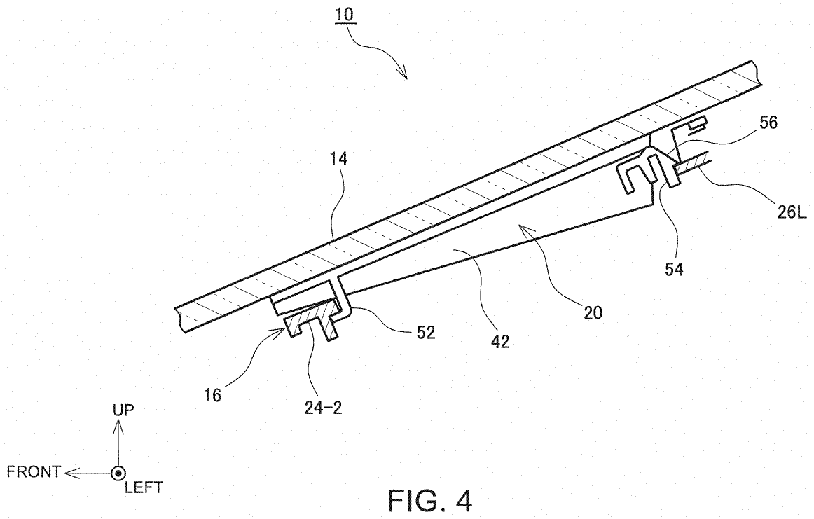

FIG. 4 is a side view of the vehicle-mounted camera unit 10 viewed from the left side. For convenience of description, the bracket 16 and the windshield 14 are illustrated in cross-section. On a front portion of the left lateral surface of the hood 20, an L-shaped hook structure 52 is formed. The L-shaped hook structure 52 extends downward along the lateral wall of the recessed structure 42, projects downward from the lateral wall of the recessed structure 42, and then bends forward. In a state in which a first section of the L-shaped hook structure 52 extending downward and a second section extending forward abut on the lateral frame 24-2 such that the L-shaped hook structure 52 is hooked on the lateral frame 24-2 (an engaged state), the front end portion of the hood 20 is supported on the upper surface of the lateral frame 24-2.

On a rear portion of the left lateral surface of the hood 20, a nailed hook structure 54 is formed. The nailed hook structure 54 swings elastically in the front-back direction with its upper end portion at the center. A nail 56 of the nailed hook structure 54 becomes thicker in the rearward direction as it goes toward its tip end, and the thickness of the nail 56 decreases sharply at a position closer to the tip end portion than the thickest portion. The front end portion of the hood 20 is supported on the upper surface of the lateral frame 24-2, and the nail 56 of the nailed hook structure 54 formed on a rear portion of the hood 20 is hooked on the hood attachment projection 26L, whereby the hood 20 is secured on the bracket 16.

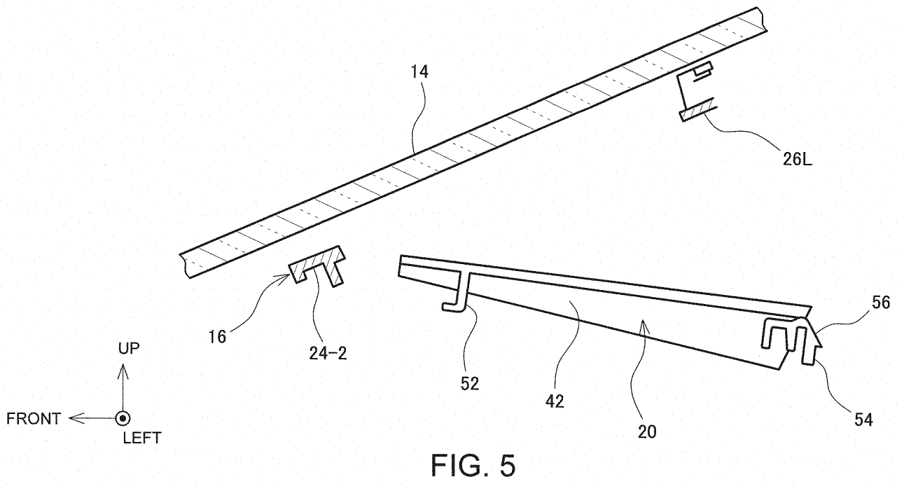

The hood 20 is removable from the bracket 16. That is, to demount the hood 20 from the bracket 16, the nailed hook structure 54 is pressed forward to thereby release the interference between the nail 56 and the hood attachment projection 26L. In this condition, the hood 20 is rotated clockwise in FIG. 4 with the engagement portion of the L-shaped hook structure 52 and the lateral frame 24-2 at the center before the hood 20 is pulled rearward. This allows the hood 20 to be demounted from the bracket 16, as illustrated in FIG. 5.

After the hood 20 is demounted from the bracket 16, the heater 18 is demounted from the hood 20. The demounted heater 18 may be inspected, and secured back on the hood 20. Alternatively, after the hood 20 is demounted from the bracket 16, the heater 18 that is defective may be demounted from the hood 20, and a new working heater 18 may be secured on the hood 20 instead. To mount the hood 20 on the bracket 16, the first section and the second section of the L-shaped hook structure 52 are made to abut on the lateral frame 24-2, and the hood 20 is then rotated counterclockwise in FIG. 4 to thereby bring the rear face of the nail 56 into contact with the hood attachment projection 26L. In this condition, the hood 20 is further pressed counterclockwise in FIG. 5, whereby the nailed hook structure 54 is flexed forward due to a force applied from the hood attachment projection 26L and received by the nail 56. The rear face of the nail 56 is slid on the hood attachment projection 26L, and the nail 56 is then hooked on the hood attachment projection 26L, whereby the hood 20 is secured on the bracket 16.

Note that although the left side structure of the hood 20 is described above, a similar L-shaped hook structure 52 and a similar nailed hook structure 54 are formed on the right side of the hood 20 as well. To secure the hood 20 on the bracket 16 or to demount the hood 20 from the bracket 16, the L-shaped hook structure 52 and the nailed hook structure 54 on the right side operate in the same manner as those on the left side. Note that the L-shaped hook structure 52 may be formed on the base surface of the hood 20, in place of on the right and left lateral surfaces of the hood 20.

As described above, the vehicle-mounted camera unit 10 has a vehicle-mounted glass heater securing structure for securing the heater 18. The hood 20 has the L-shaped hook structure 52 that extends from the hood 20 and the nailed hook structure 54 that extends from the hood 20 and elastically swings, both being formed on each of the right and left lateral surfaces of the hood 20. In a state in which the L-shaped hook structure 52 is engaged with the lateral frame 24-2 of the bracket 16, the right and left nailed hook structures 54 are hooked on the respective hood attachment projections 26R, 26L at respective positions opposed to the lateral frame 24-2.

When the right and left nailed hook structures 54 are separated from the respective hood attachment projections 26R, 26L, the hood 20 is rotatable with the engagement portion of the L-shaped hook structure 52 and the lateral frame 24-2 at the center, and removable from the engagement portion.

In the above-mentioned embodiment, the hood attachment projections 26R, 26L are formed on the bracket 16 to serve as a structure on which the respective right and left nailed hood structures 54 are to be hooked. A structure on which each of the right and left nailed hook structures 54 is to be hooked may be any other structure having such a shape that allows the nail 56 to be hooked thereon. For example, the hood attachment projections 26R, 26L may have structures projecting rightward and leftward, respectively, from the respective inside lateral surfaces of the front-back frames 22R, 22L, instead of a structure projecting in the front-back direction, for example.

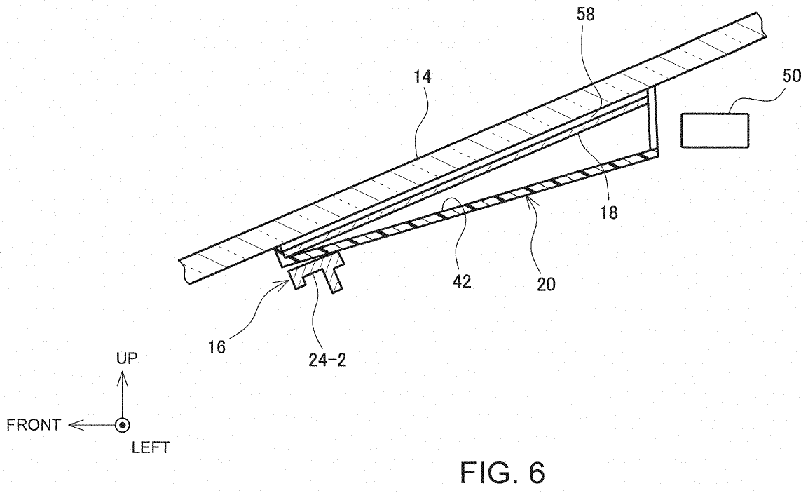

FIG. 6 is a cross sectional view of the vehicle-mounted camera unit 10 along the line AA illustrated in FIG. 2. The heater 18 covers the opening of the recessed structure 42 of the hood 20, and is opposed to the windshield 14 with a gap 58 formed between the heater 18 and the windshield 14. A structure for forming the gap 58 between the heater 18 and the windshield 14 will be described later in detail. The camera 50 is secured on the bracket 16 with its line of sight directed forward at a position behind the hood 20.

As described above, the vehicle-mounted glass heater securing structure of the vehicle-mounted camera unit 10 includes the bracket 16 and the hood 20. The camera 50 is secured on the bracket 16, and the bracket 16 is secured on an automobile. The hood 20 is secured on the bracket 16. Between the windshield 14 in front of the camera 50 and the hood 20, the line of sight of the camera 50 passes through. The hood 20 supports the heater 18 in a posture along the surface of the windshield 14 at a position in front of the camera 50 with the gap 58 formed between the heater 18 and the windshield 14. The hood 20 has the recessed structure 42 that is recessed in a direction departing from the windshield 14. The opening of the recessed structure 42 is opposed to the windshield 14.

When a voltage is applied to the pair of electrodes drawn out from the heater 18 by a power supply equipped in the automobile, the heater 18 generates heat. The heat evaporates moisture that is present on the windshield 14, whereby the field of view of the camera 50 is prevented from being hindered by the moisture.

As described above, the vehicle-mounted glass securing structure according to this embodiment holds the heater 18 such that the heater 18 is opposed to the surface of the windshield 14 on the side of the vehicle cabin 14 with the gap 58 formed between the heater 18 and the windshield 14. This can prevent close contact between the heater 18 and the windshield 14, and thus prevent formation of bubbles between the windshield 14 and the heater 18. Further, the presence of the gap 58 between the heater 18 and the windshield 14 prevents possible damage of the windshield 14 or the heater 18 when installing the heater 18. Further, the heater 18 can be readily installed even though the curvature of the heater 18 differs from that of the windshield 14.

The hood 20 and the heater 18 are removable from the bracket 16. Thus, maintenance or the like of the heater 18 is executed after the heater 18 is demounted from the bracket 16 together with the hood 20. That is, maintenance of the heater 18 is facilitated because work for the windshield 14 is unnecessary.

A method for maintenance of a heater, or a heater maintenance method, employed for a vehicle-mounted glass heater unit includes the following steps; (i) a step of releasing the hooking between the hood 20 and the bracket 16; (ii) a step of rotating the hood 20 in a direction departing from the windshield 14 with the engagement portion of the hood 20 and the bracket 16 at the center before separating the hood 20 from the bracket 16, (iii) a step of demounting the heater 18 from the hood 20; (iv) a step of securing the inspected heater 18 or a new heater 18 onto the hood 20; and (v) engaging the hood 20 with the engagement portion, rotating the hood 20 in a direction approaching the windshield 14 with the engagement portion at the center, and hooking the hood 20 on the bracket 16. In this embodiment, the hooking between the hood 20 and the bracket 16 is released by pressing the right and left nailed hook structures 54 forward to thereby release the interference between the right and left nails 56 and the hood attachment projections 26L, 26R, respectively. Further, in this embodiment, the hood 20 is hooked onto the bracket 16 by hooking the right and left nails 56 on the hood attachment projections 26R, 26L, respectively.

According to this heater maintenance method, the hood 20 is demounted from the bracket 16; the heater 18 is inspected or replaced; and the hood 20 is secured back onto the bracket 16, so that maintenance of the heater 18 can be facilitated. As the heater 18 is not in contact with the windshield 14, less mechanical burden is imposed on the heater 18 and the windshield 14.

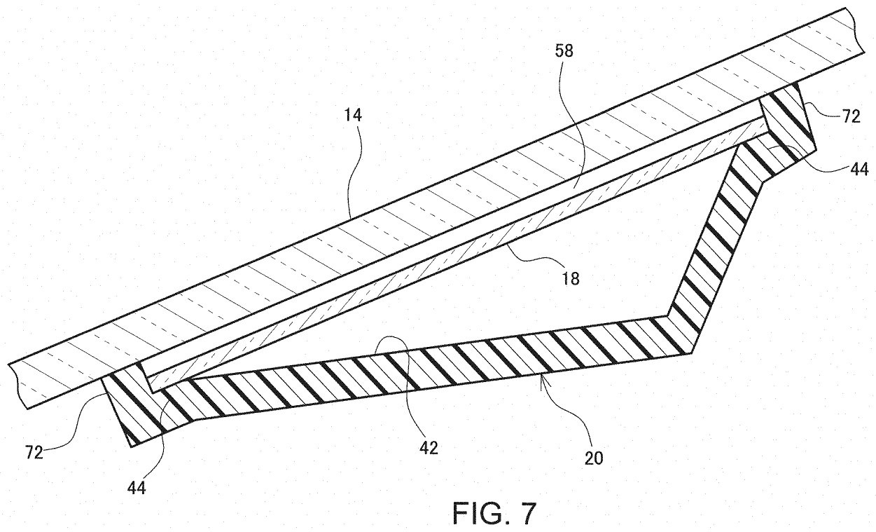

FIG. 7 illustrates a first example of a structure for the hood 20 to support the heater 18. Specifically, FIG. 7 schematically illustrates a cross-sectioned structure for the hood 20 to support the heater 18. A projecting portion 72 is formed on the circumference of the plane structure 44 formed on the hood 20, so as to project toward the windshield 14. The projecting portion 72 may have a substantially annular structure surrounding the circumference of the plane structure 44. Alternatively, the projecting portion 72 may have a substantially annular structure surrounding the circumference of the plane structure 44, with a part of that structure being removed. Still alternatively, the projecting portion 72 may have a pillar structure disposed on the circumference of the plane structure 44. The tip end of the projecting portion 72 is in contact with the surface of the windshield 14 on the side of the vehicle cabin.

The heater 18 is placed on the plane structure 44 in an inside area surrounded by the projecting portion 72. The plane structure 44 is disposed outside the recessed structure 42, constituting a support structure for supporting the heater 18 such that the heater 18 covers the opening of the recessed structure 42. The projecting portion 72 is disposed outside an area of the plane structure 44, the area for supporting the heater 18, and projects toward the windshield 14. The dimension of the height of the projection of the projecting portion 72 from the plane structure is larger than that of the thickness of the heater 18. This leaves the heater 18 supported by the hood 20 with the gap 58 formed between the heater 18 and the windshield 14.

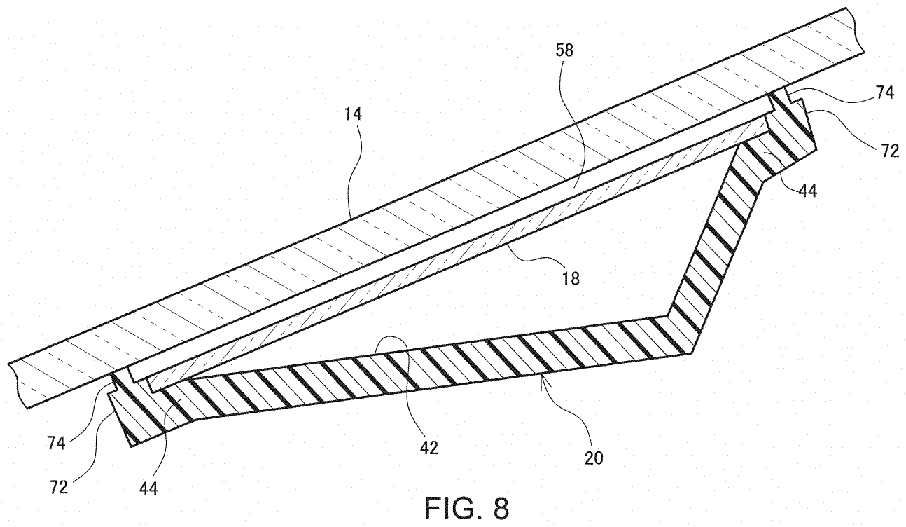

FIG. 8 illustrates a second example of a structure for the hood 20 to support the heater 18. This drawing schematically illustrates a cross-sectioned structure of the hood 20 that supports the heater 18. Similar to the structure illustrated in FIG. 7, the heater 18 is placed on the plane structure 44. The dimension of the height of the projecting portion 72 is either the same as that of the thickness of the heater 18 or smaller than that of the thickness of the heater 18, and an additional projecting portion 74 is formed on the upper surface of the projecting portion 72. The additional projection portion 74 projects from the upper surface of the projecting portion 72 toward the windshield 14. Although FIG. 8 illustrates an additional projecting portion 74 whose width is narrower than that of the projecting portion 72, the width of the additional projecting portion 74 may be the same as that of the projecting portion 72. The height of the additional projecting portion 74 is determined such that the height of the projecting portion 72 and the additional projecting portion 74 combined is higher than the thickness of the heater 18.

In the case where the projecting portion 72 has a substantially annular structure surrounding the circumference of the plane structure 44, the additional projecting portion 74 as well may have a substantially annular structure, similar to that of the projecting portion 72. Alternatively, the additional projecting portion 74 may have a substantially annular structure with a part of that structure missing. Still alternatively, the additional projecting portion 74 may have a pillar structure disposed on the projecting portion 72. In the case where the projecting portion 72 has a pillar shape, the additional projecting portion 74 may constitute a projecting pillar structure assimilating the projecting portion 72.

Although the dimension of the height of the projecting portion 72 is the same as that of the thickness of the heater 18, or smaller than that of the thickness of the heater 18, the additional projecting portion 74 is formed projecting from the upper surface of the projecting portion 72 toward the windshield 14 such that the tip end of the additional projecting portion 74 is in contact with the surface of the windshield 14 on the side of the vehicle cabin. The dimension of the height of the projecting portion 72 and the additional projecting portion 74 combined is larger than that of the thickness of the heater 18. With the above, the heater 18 is supported by the hood 20 with the gap 58 formed between the heater 18 and the windshield 14.

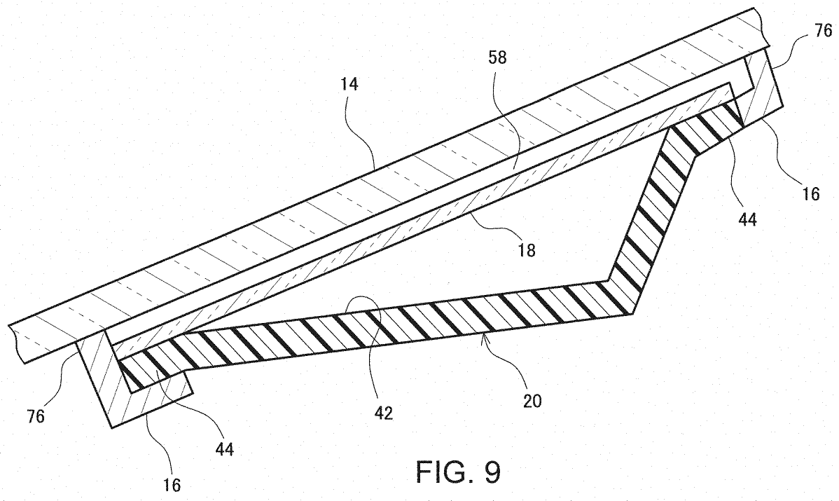

FIG. 9 illustrates a third example of a structure for the hood 20 to support the heater 18. This drawing schematically illustrates a cross-sectioned structure of the hood 20 that supports the heater 18. The heater 18 is placed on the upper surface of the plane structure 44 of the hood 20, and supported by the hood 20. A bracket projecting portion 76 is formed on the bracket 16, on which the hood 20 is secured, so as to project toward the windshield 14. The tip end of the bracket projecting portion 76 is in contact with the surface of the windshield 14 on the side of the vehicle cabin.

The bracket projecting portion 76 can be formed as a part of the frame structure around the hood 20, illustrated in FIG. 2 and FIG. 3, namely, the front-back frame 22R, the front-back frame 22L, the lateral frame 24-1, the lateral frame 24-2, or the like. That is, the bracket projecting portion 76 can be formed on the frame structure outside the hood 20. For example, the bracket projecting portion 76 may be formed by deforming the lateral frame 24-2, illustrated in FIG. 2 and FIG. 3, such that the lateral frame 24-2 extends forward of of the bracket 16 and then upward until its tip end touches the windshield 14, as illustrated in FIG. 9. Alternatively, the bracket projecting portion 76 may be formed like a bank extending in the front-back direction on each of the right and left sides of the hood 20 illustrated in FIG. 2. As a further alternative, the bank projecting portion 76 may be formed like a bank extending in the right and left direction at a position behind the hood 20. The bracket projection portion 76 in either shape is formed such that its upper end is in contact with the surface of the windshield 14 on the side of the vehicle cabin. Alternatively, the bracket projecting portion 76 may be formed in a pillar shape.

With the vehicle-mounted glass heater securing structure illustrated in FIG. 7 to FIG. 9, the heater 18 in a posture along the surface of the windshield 14 is supported by the hood 20 with the gap 58 formed between the heater 18 and the windshield 14. This prevents close contact between the heater 18 and the windshield 14, and thus formation of bubbles between the windshield 14 and the heater 18. In addition, the presence of the gap 58 between the heater 18 and the windshield 14 can prevent possible damage of the windshield 14 in installing the heater 18. Further, the heater 18 can be readily installed even though the curvature of the heater 18 differs from that of the windshield 14.

Although an embodiment in which a vehicle-mounted glass heater securing structure is used for the windshield 14 of an automobile is described in the above, the vehicle-mounted glass heater securing structure according to the present disclosure may be used for any windows of an automobile.

1. A vehicle-mounted glass heater securing structure, comprising:
a bracket having a camera secured thereon, the bracket for being secured on an automobile; and
a hood secured on the bracket in such a manner that allows a line of sight of the camera to pass through between the hood and a glass in front of the camera,
wherein
the hood supports a heater in a posture along a surface of the glass at a position in front of the camera with a gap formed between the heater and the glass.

2. The vehicle-mounted glass heater securing structure according to claim 1, wherein
the hood has
a recessed structure that is recessed in a direction departing from the glass,
a support structure disposed outside the recessed structure, the support structure being for supporting the heater such that the heater covers an opening of the recessed structure, and
a projecting portion disposed on the support structure and projecting toward the glass, and
a tip end of the projecting portion is in contact with the glass.

3. The vehicle-mounted glass heater securing structure according to claim 1, wherein
the hood has
a recessed structure that is recessed in a direction departing from the glass,
a support structure disposed outside the recessed structure, the support structure being for supporting the heater such that the heater covers an opening of the recessed structure,
a projecting portion disposed on the support structure and projecting toward the glass, and
an additional projecting portion projecting from the projecting portion toward the glass,
a dimension of a height of the projecting portion is the same as a dimension of a thickness of the heater, or smaller than the dimension of the thickness of the heater, and
a tip end of the additional projecting portion is in contact with the glass.

4. The vehicle-mounted glass heater securing structure according to claim 2, wherein
the support structure is a plane structure formed on a circumference of the recessed structure, and
the projecting portion is formed on a circumference of the plane structure.

5. The vehicle-mounted glass heater securing structure according to claim 3, wherein
the support structure is a plane structure formed on a circumference of the recessed structure, and
the projecting portion is formed on a circumference of the plane structure.

6. The vehicle-mounted glass heater securing structure according to claim 1, wherein
the hood has a recessed structure that is recessed in a direction departing from the glass,
the heater is supported so as to cover an opening of the recessed structure, and
the bracket has
a frame structure that surrounds outside of the hood, and
a bracket projecting portion that projects from the frame structure toward the glass.

7. The vehicle-mounted glass heater securing structure according to claim 1, wherein
the hood has
an L-shaped hook structure that extends from the hood, and
a nailed hook structure that extends from the hood and elastically swings, and
the nailed hook structure is hooked on the bracket at a position opposed to the frame with the L-shaped hook structure engaged with the frame included in the bracket.

8. The vehicle-mounted glass heater securing structure according to claim 7, wherein
with the nailed hook structure separated from the bracket, the hood is rotatable with an engagement portion of the L-shaped hook structure and the frame as the center, and removable from the engagement portion.

9. A vehicle-mounted glass heater unit, comprising:
the vehicle-mounted glass heater securing structure according to claim 1, and
the heater
wherein
the heater includes a low reflective film provided on a surface of the heater on a side of the glass or in an inside layer of the heater.

10. A vehicle-mounted glass heater unit, comprising:
the vehicle-mounted glass heater securing structure according to claim 1, and
the heater,
wherein
the heater includes a base in a sheet-like shape or a plate-like shape, and
the base is made of elastic or rigid material.

11. A vehicle-mounted glass heater unit, comprising:
the vehicle-mounted glass heater securing structure according to claim 1, and
the heater,
wherein
the heater includes a base in a sheet-like shape or a plate-like shape, and
the base is made of glass material.

12. A vehicle-mounted glass heater maintenance method for use with respect to a vehicle-mounted glass heater unit including
a bracket having a camera secured thereon, the bracket for being secured on an automobile,
a hood removably secured on the bracket in such a manner that allows a line of sight of the camera to pass through between the hood and a glass in front of the camera, and
a heater supported in a posture along a surface of a glass of the automobile by the hood at a position in front of the camera, the method comprising the steps of:
releasing hooking between the hood and the bracket, and
rotating the hood in a direction departing from the glass with an engagement portion of the hood and the bracket at a center to separate the hood from the bracket; and
demounting the heater from the hood.

13. The vehicle-mounted glass heater maintenance method according to claim 12, further comprising the steps of:
securing the heater on the hood; and
engaging the hood with the engagement portion, then rotating the hood in a direction approaching the glass with the engagement portion at the center, and hooking the hood on the bracket.
